(19) United States
(12) Patent Application Publication
(10) Pub. No.: US 2019/0287070 A1
(43) Pub. Date: Sep. 19, 2019

(54) QUERY EXPANSION FOR CANDIDATE SELECTION

(71) Applicant: Microsoft Technology Licensing, LLC, Redmond, WA (US)

(72) Inventors: Erik Eugene Buchanan, Mountain View, CA (US); Vijay Dialani, Fremont, CA (US); Sahin Cem Geyik, Redwood City, CA (US); Benjamin John McCann, Mountain View, CA (US); Ketan Thakkar, Santa Clara, CA (US); Patrick Cheung, San Francisco, CA (US); Nadeem Anjum, Santa Clara, CA (US); David DiCato, San Francisco, CA (US)

(21) Appl. No.: 15/922,732

(22) Filed: Mar. 15, 2018

(51) Int. Cl. G06Q 10/10; G06F 17/30

(52) U.S. Cl. CPC G06Q 10/1053; G06Q 50/01; G06F 17/30507

(57) ABSTRACT

Systems and methods for query expansion are disclosed. In some examples, a server receives, from a client device, a search query for employment candidates, the search query comprising a first set of parameters. The server determines a second set of parameters related to the first set of parameters in response to identifying a second parameter for the second set of parameters that corresponds with a first parameter from the first set of parameters, the professional records being stored in a professional data repository. The server generates, from the professional data repository, a first set of search results based on the first set of parameters and the second set of parameters. The server provides, to the client device, an output representing the first set of search results.

### CROSS-REFERENCE TO RELATED APPLICATION

This application is related to U.S. patent application Ser. No. 15/827,337, titled “RANKING JOB CANDIDATE SEARCH RESULTS,” and filed on Nov. 30, 2017, the entire disclosure of which is incorporated herein by reference.

### TECHNICAL FIELD

The present disclosure generally relates to machines configured for query expansion, including computerized variants of such special-purpose machines and improvements to such variants, and to the technologies by which such special-purpose machines become improved compared to other special-purpose machines that provide impersonation detection technology. In particular, the present disclosure addresses systems and methods for query expansion for candidate selection.

### BACKGROUND

A user may enter a query. The query may generate a narrow set of search results. Expanding the query to generate a broader set of search results may be desirable.

### BRIEF DESCRIPTION OF THE DRAWINGS

Some embodiments of the technology are illustrated, by way of example and not limitation, in the figures of the accompanying drawings.

FIG. 1 illustrates an example system in which query expansion may be implemented, in accordance with some embodiments.

FIG. 2 is a flow chart illustrating an example method for query expansion, in accordance with some embodiments.

FIG. 3 illustrates an example query including parameters, in accordance with some embodiments.

FIG. 4 is a block diagram illustrating components of a machine able to read instructions from a machine-readable medium and perform any of the methodologies discussed herein, in accordance with some embodiments.

### DETAILED DESCRIPTION

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

Some aspects of the technology described herein address the problem in the computer arts of expanding a query. For example, a user may search for professional records in a professional data repository (e.g., an Applicant Tracking System (ATS) or a data repository of a professional networking service) that include the title “software engineer” located in Fargo, North Dakota (where few software engineers live). This search may return few results, as only a small number of people in Fargo have the title “software engineer.” However, the professional data repository may include other professional records of people who do work similar to a “software engineer,” but have a different title. Hence, by solely using the query to conduct a search, a search system may be ineffective in providing a user with results that are relevant to the query.

In some cases, this problem may be solved by expanding the query to include other titles, such as “software developer,” “member of technical staff,” or “computer science researcher.” This may broaden the search, thereby generating more results. Alternatively, the query may be expanded to search for professional records having computer science degrees who live in Fargo, or professional records who are employed at software companies in Fargo. In another example, the geographic location “Fargo” could be expanded to include other geographic locations near Fargo or professional records associated with people who might be interested in relocating to Fargo (e.g., records associated with people who previously lived in Fargo or have family member(s) in Fargo).

According to some implementations, a server receives, from a client device, a search query for employment candidates. The search query includes a first set of parameters. The server determines a second set of parameters related to the first set of parameters. This is done in response to identifying a second parameter for the second set of parameters that co-occurs with a first parameter from the first set of parameters with a score exceeding a threshold. For example, the title “Realtor®” may co-occur, in some records, with the skill “real estate sales.” In some examples, the score exceeding the threshold corresponds to at least a threshold proportion of professional records associated with the first parameter also being associated with the second parameter. The professional records are stored in a professional data repository. The server generates, from the professional data repository, a first set of search results based on the first set of parameters and the second set of parameters. The server provides, to the client device, an output representing the first set of search results.

The technology is described in this document in the professional networking context and in the context of searching for a candidate for employment. However, the technology described herein may be used in other search contexts also. For example, the technology described herein may be applied to a search for a mate in a dating service or a search for a new friend in a friend-finding service.

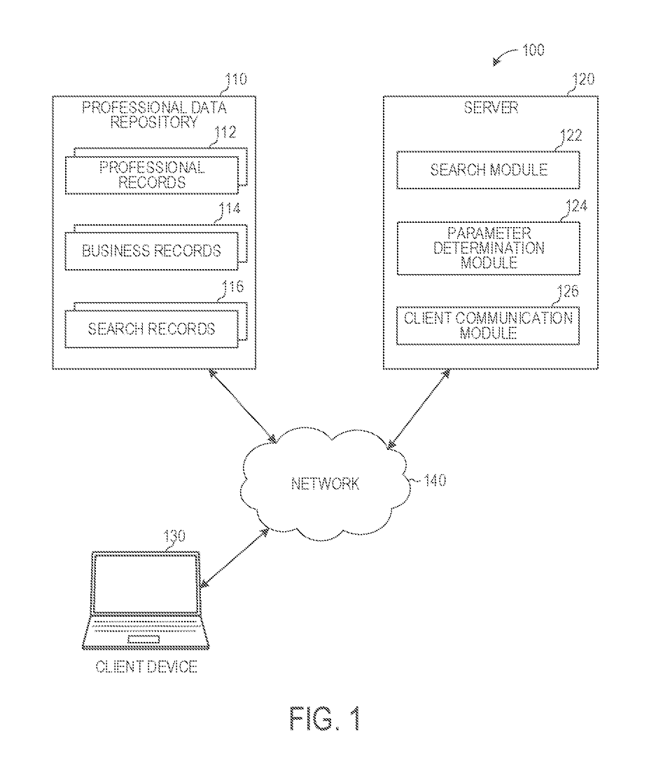

FIG. 1 illustrates an example system 100 in which query expansion may be implemented, in accordance with some embodiments. As shown, the system 100 includes a professional data repository 110, a server 120, and a client device 130 communicating with one another via a network 140. The network 140 may include one or more of the Internet, an intranet, a local area network, a wide area network, wired network, a wireless network, a cellular network, a virtual private network (VPN), and the like. While the system 100 is illustrated as including a single professional data repository 110, server 120, and client device 130, the technology described herein may also be implemented with multiple professional data repositories, servers, or client devices.

As shown, the professional data repository 110 stores professional records 112, business records 114, and search records 116. The professional records 112 may be records associated with professionals stored in a professional networking service, an Applicant Tracking System (ATS) or similar. Each professional record 112 may include one or more of: a name, a postal address, a telephone number, an email address, a current or past employer, a current or past educational institution and degree, a skill, an area of interest or expertise, an industry, years of experience, and the like. The business records 114 may be generated via the professional networking service. Each business record 114 may be a record associated with a business. Each business record 114 may include one or more of: a name, a postal address, a telephone number, an email address, an industry, an open position, a filled position, and the like. The search records 116 are records of searches. Each search record 116 may include the parameter(s) or weight(s) of the parameter(s) in the search. The search records 116 may be generated via the server 120.

As shown, the server 120 includes a search module 122, a parameter determination module 124, and a client communication module 126. In some implementations, the server 120 receives, via the client communication module 126 and from the client device 130, a search query for employment candidates. The search query includes a first set of parameters. An example of the parameters is <title is “software engineer”> and <location is “Fargo, N. Dak.”>. The server 120 determines, using the parameter determination module 124, a second set of parameters related to the first set of parameters. This determining by the parameter determination module 124 is in response to identifying a second parameter for the second set of parameters that co-occurs with a first parameter from the first set of parameters in at least a threshold proportion (e.g., 50% or 60%) of professional records 112 (stored in the professional data repository 110) associated with the first parameter. For example, at least the threshold proportion of records having <title is “software engineer”> may also have the title “software developer” (e.g., in a simultaneous or former position). The server 120 generates, using the search module 122 and from the professional data repository 110, a first set of search results based on the first set of parameters and the second set of parameters. The server provides, using the client communication module 126 and to the client device 130, an output representing the first set of search results.

The client device 130 may be any computing device. For example, the client device 130 may include a laptop, a desktop, a mobile phone, a tablet computer, a smart watch, a smart television, a personal digital assistant, a smart television, and the like. While a single client device 130 is illustrated, the technology described herein may be implemented with multiple client devices.

FIG. 1 illustrates one possible architecture of the professional data repository 110 and the server 120. However, it should be noted that different architectures for these machines may be used in conjunction with the technology described herein. Furthermore, in some cases, the technology described herein may be implemented using machines different from those show in FIG. 1.

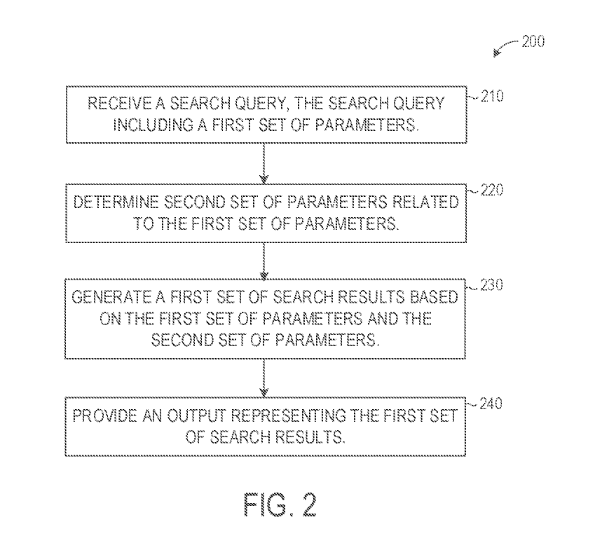

FIG. 2 is a flow chart illustrating an example method 200 for query expansion, in accordance with some embodiments. The method 200 is described here as being implemented within the system 100 of FIG. 1. However, the operations of the method 200 may also be implemented in other systems with different machines from those shown in FIG. 1.

At operation 210, the server 120 receives, from the client device 130, a search query. The search query includes a first set of parameters. In some examples, the first set of parameters includes one or more of a job title, a skill, an educational experience, an employment experience, an industry, years of experience, and a geographic location. In some examples, the search query is a query for professional records from the professional data repository 110, which stores records associated with professionals (e.g., professional records 112), records associated with businesses (e.g., business records 114), and records associated with employment candidate search queries (e.g., search records 116).

At operation 220, the server 120 determines a second set of parameters related to the first set of parameters. In some cases, the server makes the decision to determine the second set of parameters based on search results from the first set of parameters being inadequate, for example, if the first set of parameters generates less than a threshold number (e.g., 10 or 100) of search results from the professional data repository 110. This determining is in response to identifying a second parameter for the second set of parameters that co-occurs with a first parameter from the first set of parameters in at least a threshold proportion (e.g., 40% or 55%) of professional records 112 associated with the first parameter. For example, the server 120 may identify that at least the threshold percentage of professional records that include the skill “real estate sales” (which corresponds to the first parameter) include the job title “Realtor®” (which corresponds to the second parameter). The professional records 112 are stored in the professional data repository 110. Similar to the first set of parameters, in some examples, the second set of parameters includes one or more of a job title, a skill, an educational experience, an employment experience, and a geographic location.

In some cases, the second parameter co-occurring with the first parameter includes a professional record including the first parameter (e.g., “senior engineer”) as a current title and the second parameter (e.g., “junior engineer”) as a former title. In some cases, the second parameter co-occurring with the first parameter comprises a professional record indicating that a business (e.g., a business associated with one of the business records 114, such as a restaurant) hires both employees associated with the first parameter (e.g., “chef”) and employees associated with the second parameter (e.g., “waiter”). In some cases, identifying that the second parameter is related to the first parameter is based on at least a threshold number of users providing search queries (e.g., stored in the search records 116) for both the first parameter (e.g., “Realtor®”) and the second parameter (e.g., “real estate broker”). In some cases, the professional data repository 110 is associated with a professional networking service. Identifying that the second parameter is related to the first parameter is based on social connections associated with a plurality of records associated with the first parameter (e.g., “patent attorney”) including at least a threshold number of records associated with the second parameter (e.g., “inventor”).

In some cases, the server 120 computes, for a second parameter from the second set of parameters and a first parameter from the first set of parameters, a probability that a professional record (from the professional records 112 in the professional data repository 110) includes the second parameter given that the professional record includes the first parameter. The server 120 determines that the second parameter is related to the first parameter based on the probability exceeding a threshold probability (e.g., 70% or 80%).

In some cases, the second set of parameters is related to the first set of parameters based on the server 12—identifying second parameter for the second set of parameters that corresponds with a first parameter from the first set of parameters in at least a threshold proportion of professional records 112 associated with the first parameter. According to some examples, wherein the second parameter corresponding with the first parameter comprises the second parameter co-occurring with the first parameter. According to some examples, the second parameter corresponding with the first parameter comprises a plurality of users clicking on a link for a page associated with both the first parameter and clicking on a link for a page associated with the second parameter. According to some examples, the second parameter corresponding with the first parameter comprises a plurality of users applying to a job associated with the first parameter and applying to a job associated with the second parameter. According to some examples, the second parameter corresponding with the first parameter comprises a plurality of users searching for both the first parameter and the second parameter. According to some examples, the second parameter corresponding with the first parameter comprises a plurality of users following a page associated with the first parameter in a professional networking service and following a page associated with the second parameter in the professional networking service. According to some examples, the second parameter corresponding with the first parameter comprises a plurality of profiles in a professional networking service including both the second parameter and the first parameter.

At operation 230, the server 120 generates, from the professional data repository 110, a first set of search result based on the first set of parameters and the second set of parameters. For example, if the first set of parameters includes <job title is “Realtor®”> and the second set of parameters includes <skill: “real estate sales”> and <employer is “ABC Realty”>, then the first set of search results includes professional records with the job title “Realtor®,” in addition to professional records with the skill “real estate sales,” and in addition to professional records with the employer “ABC Realty.”

At operation 240, the server 120 provides, to the client device 130, an output representing the first set of search results. The output may be displayed, at the client device 130, to a user of the client device 130. A browser or other application at the client device 130 may be used to generate the display.

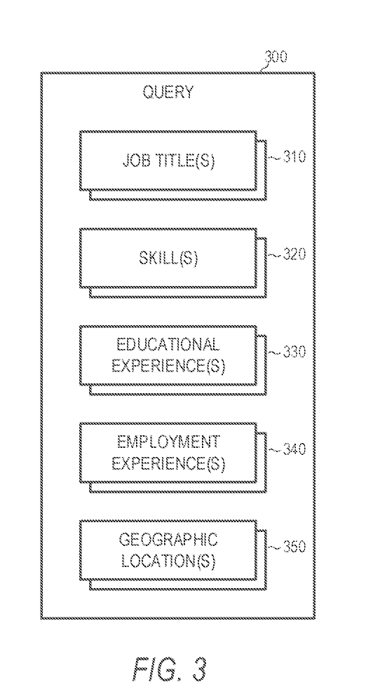

FIG. 3 illustrates an example query 300, in accordance with some embodiments. The query 300 may be transmitted from the client device 130 to the server 120, and may be used by the server 120 to search the professional data repository 110. As shown, the query 300 includes the parameters: job title(s) 310, skill(s) 320, educational experience(s) 330, employment experience(s) 340, and geographic location(s). The query 300 may be a query for employment candidates for a business. The job title(s) 310 may correspond to job title(s) the business is seeking, for example, “patent agent.” The skill(s) 320 may correspond to skills the business is seeking, for example, writing, patent prosecution, patent drafting, or client counseling. The educational experience(s) 330 may correspond to educational experiences the business is seeking, for example, Bachelor's Degree in Computer Science, Master's Degree or computer science degree. The employment experience(s) 340 may correspond to employment experience(s) the business is seeking, for example, at least two years of experience as a patent agent or technical advisor at a law firm. The geographic location(s) 300 may correspond to geographic location(s) in which the business is hiring, for example, the geographic location(s) may include the San Francisco metropolitan area and the Los Angeles metropolitan area for a business having offices in San Francisco and Los Angeles. In some examples, one or more of the parameters 310-350 may not be included in the query 300. Alternatively, all of the parameters 310-350 may be included.

Some aspects of the technology include job transition mapping. Job transition mapping may map the career path of various professional records 112 in order to determine related parameters. For example, if many professional records 112 move from “junior attorney” to “senior attorney,” a user searching for a “senior attorney,” may be interested in candidate(s) who had the title “junior attorney” for several years. Some aspects include geographic mapping. For example, if many professional records 112 of software engineers represent people who moved from New York City to San Francisco, a user searching for a software engineer in San Francisco may be interested in candidate(s) from New York City (who are more likely to move to San Francisco than candidates from other cities).

In some cases, the user of the client device 130 may be presented with both the first set of search results (based on the first set of parameters and the second set of parameters) and an original set of search results based only on the first set of parameters. The user may be prompted to specify which set of search results he/she prefers, or his/her preference may be inferred (e.g., if the user spends more time studying one set of search results or selects more search results from one set for getting additional information). The server 120 may determine whether to apply the method 200 to future queries (e.g., from other client devices) based on the set of search results that the user prefers.

According to some implementations, similarity between various parameters in a search query or in professional record(s) are computed. Techniques for computing similarity are discussed, for example, in U.S. patent application Ser. No. 15/827,337, titled “RANKING JOB CANDIDATE SEARCH RESULTS,” and filed on Nov. 30, 2017, the entire disclosure of which is incorporated herein by reference.

According to some aspects, the server 120, given a title, attempts to determine additional titles that are similar or synonymous, so as to generate more search results for a search query with the title. For example, “quality assurance engineer” may be synonymous with “quality assurance tester.” Two titles may be determined to be similar based on co-occurrence of titles in the professional records 112 (e.g., a professional record 112 indicates that a person was a “quality assurance engineer” at Company A and a “quality assurance tester” at Company B) or co-occurrence of education, skills, or seniority in records having the two titles (e.g., a first professional record 112 of a “quality assurance engineer” and a second professional record 112 of a “quality assurance tester” both have Bachelor's Degrees in Computer Science, the skill “programming,” and five years of seniority).

In some cases, the data repository 110 (or another data repository) stores a set of titles that are similar to one another, to be used for identifying the similar titles. For example, the data repository 110 may store an indication that the tiles “Realtor®,” “real estate broker,” and “real estate agent” are similar. The data repository 110 may store an indication that the titles “quality assurance engineer,” “quality assurance tester,” and “quality assurance programmer” are similar. The similar titles may be identified based on titles requiring similar education, seniority, and/or skills or based on co-occurrence of the similar titles in the professional records 112.

According to some methodologies, a similarity score is computed between two titles: title1 and title2. The similarity score is based on professional records 112 that had both titles, common skills, and the common field of study in terms of the professional records that had at least one of the titles. For each title1-title2 combination, the server 120 may calculate p(title1|title2)−the probability that a professional record 112 that has title2 also has title1. In some cases, for each title-skill combination, the server 120 calculates p(skill|title)−the probability that a professional record 112 that has the title also has the skill. In some cases, for each title-field of study combination, the server 120 calculates p(field|title)−the probability that a professional record 112 that has the title also has the field of study. Some aspects look at the similarity of two titles due to the similarity in these calculated empirical probability values. Titles similar to each other, where similarity is calculated in this manner, can be used to expand each other. In other words, if one of them exists in the query, the other can be add to the same query for expansion. In some cases, each title may also be associated with a seniority level. For example, the title “junior attorney” may correspond to attorneys having 0-5 years of experience, and the title “senior attorney” may correspond to attorneys having at least five years of experience. According to some aspects, the server 120 conducts implicit filtering according to seniority of titles. In some aspects, a combined similarity is computed as the product of similarities along the dimensions of one or more of titles, skills, fields of study, and the like.

Several evaluation methodologies may be used with the technology described herein. Online evaluation may include applying title similarity as a way to increase the number of titles to increase recall. However, in some cases, this may reduce precision (as there may be some marginally relevant results). Offline evaluation may include creating a title set via consensus. In some cases, the server 120 may ask a set of users whether the similar items returned by different algorithms/models for the title set is indeed similar. Crowdsourcing may be used to confirm the similarity of titles that are suggested as similar by various algorithms/models. Offline logs may be used to simulate title expansion. In some cases, cross-validation may be used to determine set(s) of similar titles. Titles may be identified as generic and specific within a category. For example, a category may be “teaching,” with a generic title—“teacher”—and a specific title—“mathematics teacher.”

In some cases, if a search query for candidates produces less than a threshold number (e.g., 1000) of results, the geographic constraints in the query may be relaxed. Hiring managers generally prefer local candidates over remote candidates, as local candidates do not have moving expenses and are more likely to be interested in remaining in the geographic location of the job. However, the availability of candidates is not uniform across geographic regions (e.g., there are more programmers near San Francisco, Calif. than near Fargo, N. Dak.). This may lead to a low quality user experience in regions where there are few professionals having certain title(s), making geographic constraint relaxation desirable.

In some cases, geographic criteria in a search query are relaxed such that there are at least a threshold number (e.g., 1000) of search results. In some cases, if there are more than the threshold number of candidates in the geographic region of the search query, then the geographic constraints might not be relaxed. The geographic constraint is relaxed if there are fewer than the threshold number of candidates. The candidates in the search results who are outside of the geographic region indicated in the search query should be candidates who are more likely (than others) to take a job in or move to that geographic region. For example, if a person lives in San Francisco but has a phone number with the area code associated with Fargo, N. Dak. (area code 701), that person is more likely to have connections (e.g., family or education) in Fargo and thus, is more likely to consider relocating to Fargo than another professional in San Francisco.

Relaxation may be accomplished by including nearby geographic regions (e.g., by increasing the radius of the search) or including other geographic regions that have historically contributed talent to the geographic region of the search. For example, if people have historically moved from Des Moines, Iowa to Fargo, N. Dak. for jobs, then the Des Moines region could be added to the search for the position in Fargo.

Some aspects analyze the global liquidity for a given title, analyze regional liquidity for a given title, and analyze recent transitions to compute transition probabilities between any two geographic regions. Analyzing global liquidity for a given title includes computing the proportion of professionals with the given title who changed geographies during a predetermined time period, for example, the proportion of professional records 112 associated with the title “patent attorney” who moved from one geographic region to another during the year 2016. Analyzing regional liquidity for a given title includes computing the probability of a professional with a given title moving into or out of a region during a given time period, for example, computing the proportion of professional records associated with the title “patent attorney” who lived in San Francisco on Jan. 1, 2016, who moved out during the year 2016, or the proportion of professional records associated with the title “patent attorney” who lived in San Francisco on Dec. 31, 2016, who moved into San Francisco during the year 2016. Analyzing recent transitions to compute transition probabilities between any two geographic regions includes, for example, computing the proportion of professional records associated with the title “patent attorney” who lived in Boston, Mass. on Jan. 1, 2016, and who moved into San Francisco during the year 2016.

In summary, two techniques may be used for geographic relaxation: (1) expanding the spatial radial search (e.g., searching within 200 km of Fargo, N. Dak., rather than within 100 km of Fargo, N. Dak.), and (2) expansion based on migratory patterns between geographic locations (e.g., searching not only in Fargo, N. Dak., but also in other cities from which professionals are likely to move to Fargo). The migratory patterns between geographic locations are based on position transition data. This data suggests that the professionals (e.g., associated with the professional records 112) are more likely to migrate from non-geospatially connected regions. We use association mining to determine the migratory patterns between the locations and create geo-synonyms based on user profile data. These geo-synonyms are very sparse when considered on a per title basis. As a result, we use the aggregate data to generate these synonyms. In some cases, the geographic location is recursively relaxed and eventually expands to cover all suitable candidates that satisfy other attributes in the search query.

Some aspects of the technology described herein refer to expansion based on co-occurrence. However, in some cases, the co-occurrence may be expanded to include any information based upon the output of some function. This function may be a direct co-occurrence count or another, possibly more complicated, function. In some cases, a machine learning model, such as a factorization machine, may be used. One example of a factorization machine is described in U.S. patent application Ser. No. 15/827,337, titled “RANKING JOB CANDIDATE SEARCH RESULTS,” and filed on Nov. 30, 2017, the entire disclosure of which is incorporated herein by reference. Alternatively, a deep neural network may be used in addition to or in place of the factorization machine. The deep neural network or the factorization machine may model nearness in a vector space, but not direct co-occurrence. In one example, assume Corporate Lawyer and Corporate Attorney both co-occur with Corporate Counsel, but not with each other. The factorization machine model may be able to capture that Corporate Lawyer and Corporate Attorney are related to each other despite not directly co-occurring with each other. Some models, such as the factorization machine, may capture relatedness in a non-symmetric manner. For example, if a user searches for the skill Java then the more specific skill Junit may be added to expand the query (as all search results with the skill Junit necessarily also have the skill Java). However, if a user searches for Junit, then the more general term Java might not be added (as the user is not interested in search results with the skill Java that lack the skill Junit).

In some cases, speculative query expansion may be used. A search ranking model may return a score for each search result, and it may be desirable to limit the number of terms added to a query expansion for performance reasons. A query may be executed against each expansion term to identify which expansion term(s) return the highest score(s). In some implementations, there may be multiple ways to determine highest scores. For instance, the highest store may be at position at position 1 or the highest score may be at position n (where n is any positive integer, for example, 100). Alternatively, the highest mean score of top n or the highest median score of the top n may be used.

The query expansion may be done using different data sources in addition to, or in place of, the co-occurrence. For example, co-clicks (the same user(s) access both the company page of a first business and the company page of a second business in a professional networking service), co-applies (the same user(s) apply for jobs at both the first business and the second business), co-queries (the same user(s) search for both a first query term (e.g., corporate attorney) and a second query term (e.g., corporate lawyer)), and/or co-follows (the same user(s) follow the first business and the second business in the professional networking service) may be used. In some cases, profile co-occurrence (e.g., a professional record 112 indicating that a person worked at both the first business and the second business) may be used.

The technology is described herein in the professional networking and employment candidate search context. However, the technology described herein may be useful in other contexts also. For example, the technology described herein may be useful in any other search context. In some embodiments, the technology described herein may be applied to a search for a mate in a dating service or a search for a new friend in a friend-finding service.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-3 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “Internet of Things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Example Machine Architecture and Machine-Readable Medium

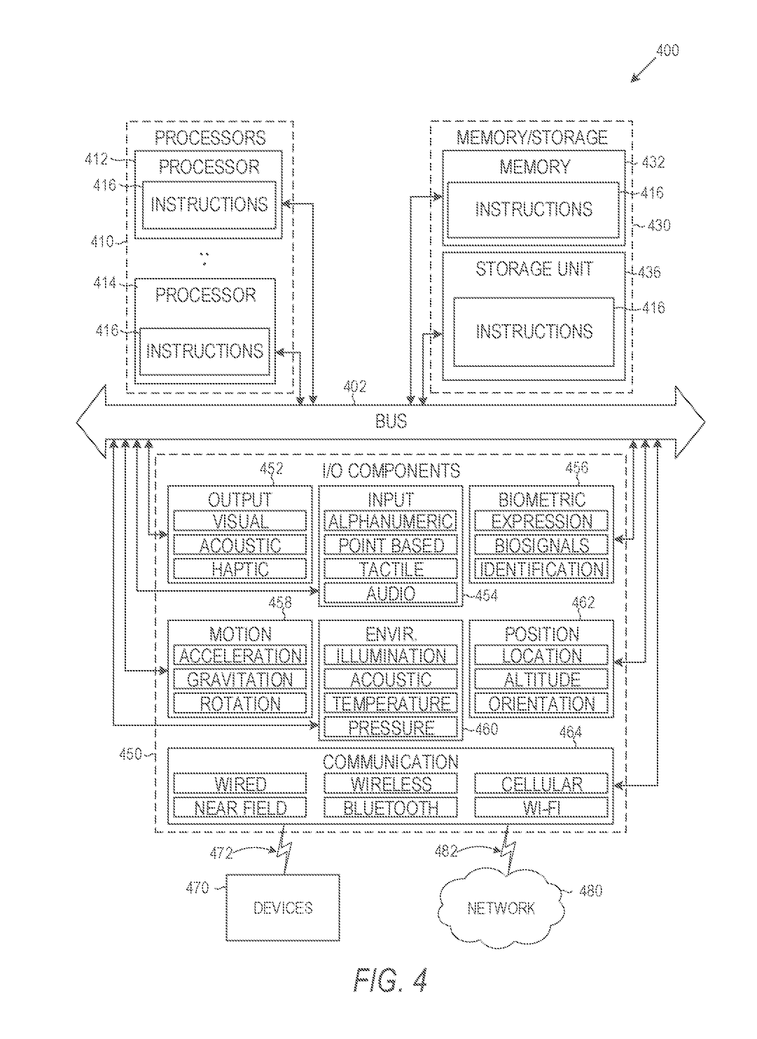

FIG. 4 is a block diagram illustrating components of a machine 400, according to some example embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein may be executed. The instructions 416 transform the general, non-programmed machine into a particular machine programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

The machine 400 may include processors 410, memory/storage 430, and I/O components 450, which may be configured to communicate with each other such as via a bus 402. In an example embodiment, the processors 410 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 412 and a processor 414 that may execute the instructions 416. The term “processor” is intended to include multi-core processors that may comprise two or more independent processors (sometimes referred to as “cores”) that may execute instructions 416 contemporaneously. Although FIG. 4 shows multiple processors 410, the machine 400 may include a single processor with a single core, a single processor with multiple cores (e.g., a multi-core processor), multiple processors with a single core, multiple processors with multiples cores, or any combination thereof.

The memory/storage 430 may include a memory 432, such as a main memory, or other memory storage, and a storage unit 436, both accessible to the processors 410 such as via the bus 402. The storage unit 436 and memory 432 store the instructions 416 embodying any one or more of the methodologies or functions described herein. The instructions 416 may also reside, completely or partially, within the memory 432, within the storage unit 436, within at least one of the processors 410 (e.g., within the processor's cache memory), or any suitable combination thereof, during execution thereof by the machine 400. Accordingly, the memory 432, the storage unit 436, and the memory of the processors 410 are examples of machine-readable media.

As used herein, “machine-readable medium” means a device able to store instructions (e.g., instructions 416) and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 416. The term “machine-readable medium” shall also be taken to include any medium, or combination of multiple media, that is capable of storing instructions (e.g., instructions 416) for execution by a machine (e.g., machine 400), such that the instructions, when executed by one or more processors of the machine (e.g., processors 410), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 450 may include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 may include many other components that are not shown in FIG. 4. The I/O components 450 are grouped according to functionality merely for simplifying the following discussion and the grouping is in no way limiting. In various example embodiments, the I/O components 450 may include output components 452 and input components 454. The output components 452 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 454 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 450 may include biometric components 456, motion components 458, environmental components 460, or position components 462, among a wide array of other components. For example, the biometric components 456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 458 may include acceleration sensor components (e.g., accelerometer), gravitation sensor components, rotation sensor components (e.g., gyroscope), and so forth. The environmental components 460 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 462 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 450 may include communication components 464 operable to couple the machine 400 to a network 480 or devices 470 via a coupling 482 and a coupling 472, respectively. For example, the communication components 464 may include a network interface component or other suitable device to interface with the network 480. In further examples, the communication components 464 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 470 may be another machine or any of a wide variety of peripheral devices (e.g., a peripheral device coupled via a USB).

Moreover, the communication components 464 may detect identifiers or include components operable to detect identifiers. For example, the communication components 464 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 464, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 480 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 480 or a portion of the network 480 may include a wireless or cellular network and the coupling 482 may be a Code Division Multiple Access (CDMA) connection, a Global System for Mobile communications (GSM) connection, or another type of cellular or wireless coupling. In this example, the coupling 482 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 4G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 416 may be transmitted or received over the network 480 using a transmission medium via a network interface device (e.g., a network interface component included in the communication components 464) and utilizing any one of a number of well-known transfer protocols (e.g., HTTP). Similarly, the instructions 416 may be transmitted or received using a transmission medium via the coupling 472 (e.g., a peer-to-peer coupling) to the devices 470. The term “transmission medium” shall be taken to include any intangible medium that is capable of storing, encoding, or carrying the instructions 416 for execution by the machine 400, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, from a client device, a search query for employment candidates, the search query comprising a first set of parameters;
identifying a second set of parameters, each second parameter from the second set of parameters corresponding with a first parameter from the first set of parameters with a score exceeding a threshold, the score indicating co-occurrence of the first parameter and the second parameter, the professional records being stored in a professional data repository;
generating, from the professional data repository, a first set of search results based on the first set of parameters and the second set of parameters; and
providing, to the client device, an output representing the first set of search results.

2. The method of claim 1, wherein the score exceeding the threshold corresponds to at least a threshold proportion of the professional records associated with the first parameter also being associated with the second parameter.

3. The method of claim 1, wherein determining the second set of parameters related to the first set of parameters comprises:
computing, for a second parameter from the second set of parameters and a first parameter from the first set of parameters, a probability that a professional record includes the second parameter given that the professional record includes the first parameter; and
determining that the probability exceeds a threshold probability.

4. The method of claim 1, wherein the second parameter corresponding with the first parameter comprises the second parameter co-occurring with the first parameter in records in the professional data repository.

5. The method of claim 4, wherein the second parameter co-occurring with the first parameter comprises a professional record including the first parameter as a current title and the second parameter as a former title.

6. The method of claim 4, wherein the second parameter co-occurring with the first parameter comprises a professional record indicating that a business hires both employees associated with the first parameter and employees associated with the second parameter.

7. The method of claim 1, wherein the second parameter corresponding with the first parameter comprises a plurality of users clicking on a link for a page associated with both the first parameter and clicking on a link for a page associated with the second parameter.

8. The method of claim 1, wherein the second parameter corresponding with the first parameter comprises a plurality of users applying to a job associated with the first parameter and applying to a job associated with the second parameter.

9. The method of claim 1, wherein the second parameter corresponding with the first parameter comprises a plurality of users searching for both the first parameter and the second parameter.

10. The method of claim 1, wherein the second parameter corresponding with the first parameter comprises a plurality of users following a page associated with the first parameter in a professional networking service and following a page associated with the second parameter in the professional networking service.

11. The method of claim 1, wherein the second parameter corresponding with the first parameter comprises a plurality of profiles in a professional networking service including both the second parameter and the first parameter.

12. The method of claim 1, wherein identifying that the second parameter is related to the first parameter is based on at least a threshold number of users providing search queries for both the first parameter and the second parameter.

13. The method of claim 1, wherein identifying that the second parameter is related to the first parameter is based on social connections associated with a plurality of records associated with the first parameter including at least a threshold number of records associated with the second parameter.

14. The method of claim 1, wherein the professional data repository comprises a data repository of a professional networking service storing records associated with professionals, records associated with businesses, and records associated with employment candidate search queries.

15. The method of claim 1, wherein the first set of parameters or the second set of parameters comprises one or more of: a job title, a skill, an educational experience, an employment experience, an industry, years of experience, and a geographic location.

16. A non-transitory machine-readable medium storing instructions which, when executed by processing circuitry of at least one machine, cause the processing circuitry to perform operations comprising:
receiving, from a client device, a search query for employment candidates, the search query comprising a first set of parameters;
identifying a second set of parameters, each second parameter from the second set of parameters corresponding with a first parameter from the first set of parameters with a score exceeding a threshold, the score indicating co-occurrence of the first parameter and the second parameter, the professional records being stored in a professional data repository;
generating, from the professional data repository, a first set of search results based on the first set of parameters and the second set of parameters; and
providing, to the client device, an output representing the first set of search results.

17. The machine-readable medium of claim 16, wherein identifying that the second parameter is related to the first parameter is based on at least a threshold number of users providing search queries for both the first parameter and the second parameter.

18. The machine-readable medium of claim 16, wherein identifying that the second parameter is related to the first parameter is based on social connections associated with a plurality of records associated with the first parameter including at least a threshold number of records associated with the second parameter.

19. A system comprising:
processing circuitry; and
a memory storing instructions which, when executed by the processing circuitry, cause the processing circuitry to perform operations comprising:
receiving, from a client device, a search query for employment candidates, the search query comprising a first set of parameters;
identifying a second set of parameters, each second parameter from the second set of parameters corresponding with a first parameter from the first set of parameters with a score exceeding a threshold, the score indicating co-occurrence of the first parameter and the second parameter, the professional records being stored in a professional data repository;
generating, from the professional data repository, a first set of search results based on the first set of parameters and the second set of parameters; and
providing, to the client device, an output representing the first set of search results.

20. The system of claim 19, wherein identifying that the second parameter is related to the first parameter is based on at least a threshold number of users providing search queries for both the first parameter and the second parameter.
